(19) United States
(12) Patent Application Publication
(10) Pub. No.: US 2015/0378754 A1
(43) Pub. Date: Dec. 31, 2015

(54) METHOD FOR INTERRUPTING THE EXECUTION OF AN OVERALL PROGRAM OF AN ELECTRONIC CONTROL UNIT

(71) Applicant: dSPACE digital signal processing and control engineering GmbH, Paderborn (DE)

(72) Inventors: Lars STOCKMANN, Paderborn (DE); Fabian EDLING, Extertal (DE)

(73) Assignee: dSPACE digital signal processing and control engineering GmbH, Paderborn (DE)

(21) Appl. No.: 14/750,122

(22) Filed: Jun. 25, 2015

(30) Foreign Application Priority Data
Jun. 26, 2014 (EP) 14174029.0

(51) Int. Cl. G06F 9/455

(52) U.S. Cl. CPC G06F 9/455

(57) ABSTRACT

A method for interrupting an execution of an overall program of an electronic control unit, wherein the overall program has a first program and a second program. A graphical modeling environment is provided that has graphical model elements, wherein the first program is represented by a first model element, and the second program is represented by a second model element, and the link between the first program and the second program is represented by a third model element. A halt condition is specified by the modeling environment, wherein a program status change leading to interruption of the execution of the overall program is specified by means of the halt condition, the overall program is executed, a program status change is detected during execution of the overall program. The execution of the overall program is interrupted when the program status change specified in the halt condition takes place.

This nonprovisional application claims priority under 35 U.S.C. §119(a) to European Patent Application No. EP 14174029.0, which was filed on Jun. 26, 2014, and which is herein incorporated by reference.

### BACKGROUND OF THE INVENTION

1. Field of the Invention

The present invention relates to a method for interrupting an execution of an overall program of an electronic control unit (ECU).

2. Description of the Background Art

Control units are electronic modules that are predominantly installed in places where something is electronically controlled or regulated. Electronic control units are used in the automotive field, in particular, where they perform such tasks as controlling mechanical or electric actuators and evaluating sensor data. Control units can be considered embedded systems. Accordingly, an overall program for controlling the electronics, for processing data, and for communication is executed on a control unit.

In the development process for an overall program of an electronic control unit, it is customary for many developers to work on the programming simultaneously. In this process, the individual aspects of the overall program, such as, firstly, the program architecture, which is to say the linking or communication of the individual programs or individual functionalities, and secondly the individual functions or programs in and of themselves, are oftentimes developed with different tools in a model-based way. This distributed process is prone to error.

Exacting requirements are placed on the program architecture of electronic control units, particularly in the automotive industry. In the automotive industry it is necessary to ensure by means of the program architecture that individual functionalities or programs can be re-used, exchanged, scaled, and integrated under the premise of maximal functional reliability. In order to fulfill these requirements, various standards exist in the automotive industry, for instance the “Automotive Open System Architecture” (AUTOSAR), via which the specifications are predefined for the architecture of the overall program.

At the end of the development process, after the overall program has been assembled by a modeling environment in conformity with a standard or a specification, testing normally follows to verify whether the overall program fulfills the requirements of the architecture model and meets the specification, whether proper functionality of the individual programs is provided, and whether the components of the overall program work together properly.

The SystemDesk modeling environment for graphical modeling of an overall program of an electronic control unit is known from dSPACE GmbH's product catalog for the year 2014 (pages 40-49, http://www.dspace.com/de/gmb/home/medien/product_info.cfm); this modeling environment also supports simulation-based testing for verification of the abovementioned aspects.

The options available until now for verification of the overall program in conjunction with simulation-based testing are source code debugging and plotting of measurement variables.

### SUMMARY OF THE INVENTION

It is therefore an object of the invention to provide an efficient method that further develops the conventional art.

The object is attained, in an exemplary embodiment, by a method for interrupting an execution of an overall program of an electronic control unit, wherein the overall program has a first program with a first variable, wherein the first program stores a first value of the first variable in a first memory area or reads the first value of the first variable out from the first memory area, and has a second program with a second variable, wherein the second program stores the first value of the first variable from the first memory area of the memory or reads the first value of the first variable out from the first memory area in order to establish a link between the first program and the second program, wherein a graphical modeling environment is provided, and the modeling environment has graphical model elements, wherein, in the graphical modeling environment, the first program is represented by a first model element, and the second program is represented by a second model element, and the link between the first program and the second program is represented by a third model element. A halt condition can be specified by the modeling environment, wherein a program status change leading to interruption of the execution of the overall program can be specified by the halt condition. The overall program is executed, a program status change is detected during execution of the overall program. A program status change can include: a start and/or end of the execution of the first and/or second program, and/or a read and/or write access to the first value of the first memory area, and/or a change in the first value of the first memory area. The execution of the overall program can be interrupted when the program status change specified in the halt condition occurs.

An advantage of the invention resides in the fact that a halt condition can be specified intuitively, quickly, and easily within the modeling environment for the architecture of the overall program, by which means the overall program can be tested quickly and straightforwardly. In this way, high functional reliability of the overall program of the control unit is ensured, which is extremely important, especially in safety-critical controllers in motor vehicles, as for example control of intervention in the steering or in the drive train.

Interrupting the execution of the overall program, e.g. by the start of execution of a program, allows identification during testing of, for example, whether, when, and in what context a program or an individual functionality is executed during execution of the overall program. Furthermore, the interruption of the execution of the overall program during a read or write access to a value of a memory allows an access that may be undesirable or unauthorized to be detected.

Moreover, the method according to the invention provides an efficient and simple option for finding errors in the architecture of the overall program and/or in the implementations of the individual programs on the basis of architecture models, and in so doing to avoid the aforementioned disadvantages of prior art methods.

Another advantage of the method according to the invention resides in the fact that the halt conditions can be specified in such a manner that multiple program status changes can be combined causally and/or temporally with one another, and the execution of the overall program is not stopped until the program status changes occur in the specified combination. Consequently, the program execution can be interrupted, for example, if, after a program status change, e.g. the execution of a program or an access to a value of a memory, another program status change occurs, such as the execution of another program or an access to another value of a memory, which can be understood to be a temporal link. The program execution can also be interrupted when a program status change occurs and a value of a memory simultaneously takes on a defined value, which can be understood to be a causal link.

A known problem in testing an overall program resides in the fact that the high-level language source code of the overall program or of individual programs/functions is not known or is not accessible, e.g. when object code or encrypted code are present. Until now, for testing it was first necessary to find the locations in the code that correspond to certain elements in the model in order to set a breakpoint there for source code debugging. And lastly, the program code generally is distributed among multiple files, which impedes conventional source code debugging.

In an embodiment the halt condition can take place in such a manner that the first model element and/or the second model element is selected in a first step, and a selection and/or input takes place in a second step. It can be specified with the selection and/or input that the program execution should be interrupted upon the start and/or end of the execution of the first program and/or upon the start and/or end of the execution of the second program, and that the execution of the overall program is interrupted upon the start and/or end of the execution of the first program and/or upon the start and/or end of the execution of the second program.

In an embodiment it is preferred for specification of the halt condition to take place in such a manner that the third model element is selected in a first step, and a selection and/or input takes place in a second step, wherein it is specified with the selection and/or input that the program execution should be interrupted upon a read and/or write access to the first value of the first memory area and/or upon a change to the first value of the first memory area, and that the execution of the overall program is interrupted upon a read and/or write access to the first value of the first memory area and/or upon a change to the first value of the first memory area.

As a result of the specification of the halt condition using the graphical model element in accordance with the two foregoing embodiments, the configuration process for the test is significantly accelerated and is intuitive in design. At the same time, errors are avoided here that could arise in the manual assignment of program code components to graphical model elements.

In another embodiment, the first variable can be represented by a fourth graphical model element, and the specification of the halt condition takes place in such a manner that the fourth model element is selected in a first step, and a selection and/or input takes place in a second step, wherein it is specified with the selection and/or input that the program execution should be interrupted upon a read and/or write access to the first value of the first memory area and/or upon a change to the first value of the first memory area, and that the execution of the overall program is interrupted upon a read and/or write access to the first value of the first memory area and/or upon a change to the first value of the first memory area.

The modeling environment can contain additional graphical model elements that represent, for example, variables or interfaces of programs. Using the additional model element, halt conditions can be specified that are linked to the variable or memory area represented by the model element.

In an embodiment, the modeling environment comprises a hierarchical tree structure, wherein the hierarchical tree structure includes a node, and the node represents the first program and/or the first variable and/or the first memory area, wherein specification of the halt condition takes place in such a manner that the node is selected in a first step, and a selection and/or input takes place in a second step, wherein it is specified with the selection and/or input that the program execution should be interrupted upon the start and/or end of the execution of the first program, and/or upon a read and/or write access to the first value of the first memory area, and/or upon a change to the first value of the first memory area.

A hierarchical tree structure offers an alternative form of display for representing a program and/or variable. Details of the program architecture are accessible more quickly in the tree structure than in a representation with graphical model elements, which results in advantages here from faster and easier configuration of the test method when halt conditions are specified in the hierarchical tree structure.

In an embodiment, the first program comprises a subprogram and/or a function, and a start and/or end of the execution of the subprogram and/or a start and/or end of the execution of the function is considered a program status change, and the execution of the overall program is interrupted upon a start and/or end of the execution of the subprogram and/or upon a start and/or end of the execution of the function.

In an embodiment, the overall program can be modeled in accordance with the specifications of the AUTOSAR standard by means of the graphical modeling environment, wherein a program code of the overall program and/or a program code of the first program is present, wherein the program code at least partially meets the specifications of the AUTOSAR standard, and the first model element and/or the second model element and/or the third model element and/or the fourth model element represents a component of the program code of the overall program and/or a component of the program code of the first program.

Another embodiment provides that the AUTOSAR standard defines a Run-Time Environment (RTE) event, and the RTE event is considered a program status change, and the execution of the overall program is interrupted when the RTE event occurs.

The use of AUTOSAR-compliant specifications for the architecture offers the advantage that efficient assignment of graphical model elements to components of the program code of the overall program is made possible by this means. This is accomplished through symbols that are defined by the standard and are associated with the occurrence of the program status changes. In this context, a symbol is a named entity within a program. The symbols of an executable program unit represent the variables and functions that are visible to a compiler/linker through the names. The variables and functions map to the relevant identifiers, which is to say variables and function definitions, in the source code from which the executable program unit is defined. In the AUTOSAR standard, the naming of functions follows defined naming schemes. For example, the name for an explicit read access through the AUTOSAR runtime environment, which is also known under the abbreviation RTE, is structured as follows: “Rte_Read_<p>_<o>” where <p> represents the name of the port and <o> represents the name of the variable prototype, which is to say the name of the container of the value to be read within the sender-receiver interface that categorizes the port. The symbols can be monitored, which is to say that a change or a call can be detected.

In another embodiment, a source code debugger is provided, and the execution of the overall program and the detection of the program status change are carried out by means of the source code debugger in such a manner that a breakpoint in the source code is identified by means of the halt condition, and the breakpoint is communicated to the source code debugger.

The use of a source code debugger provides the advantage, firstly, that already-existing mechanisms for detection and interruption of program execution can be used here. Another advantage in the use of a source code debugger resides in the fact that there is no need to modify the source code of the programs and/or of the overall program.

An additional embodiment provides that the component of the program code of the overall program and/or the component of the program code of the first program occupies a unique position within the program code, the position is identified, and a program instruction for detecting the program status change and/or interrupting the execution of the overall program is inserted before and/or after the position, or the component of the program code is replaced by a program instruction for detecting the program status change and/or interrupting the execution of the overall program.

In an embodiment, the method can be carried out in the event of execution of the overall program by means of a simulation of the processor instruction set.

According to an embodiment, the method takes place in such a manner that the component of the program code of the overall program and/or the component of the program code of the first program occupies a unique position within the program code, the position is identified, and a program code section of the overall program and/or program is displayed, wherein the program code section contains the component, and the program status change specified in the halt condition takes place by means of the component.

By this means, the source code section that is responsible for the occurrence of a halt condition can be detected quickly.

According to another embodiment, the program status change can be stored in a memory in a chronological database of a computer system if it does not result in an interruption of the program execution.

This makes it possible to inspect progress over time of the execution of the overall program. In this way it is possible to identify the relative or absolute time at which a program was started and ended, and what memory areas the programs have accessed. In addition, changes and concrete values of memory areas are displayed.

In another embodiment, a modification of the first value of the first variable from the first memory area is performed. The modification is made after the interruption of the execution of the overall program. Following the modification, the execution of the overall program is continued.

Further scope of applicability of the present invention will become apparent from the detailed description given hereinafter. However, it should be understood that the detailed description and specific examples, while indicating preferred embodiments of the invention, are given by way of illustration only, since various changes and modifications within the spirit and scope of the invention will become apparent to those skilled in the art from this detailed description.

### BRIEF DESCRIPTION OF THE DRAWINGS

The present invention will become more fully understood from the detailed description given herein below and the accompanying drawings which are given by way of illustration only, and thus, are not limitive of the present invention, and wherein:

FIG. 1 illustrates an embodiment of the functional sequence of a method according to the invention,

FIG. 2 is a schematic view of an embodiment according to the invention of a graphical modeling environment, and

FIG. 3 illustrates an embodiment of a hierarchical tree structure.

### DETAILED DESCRIPTION

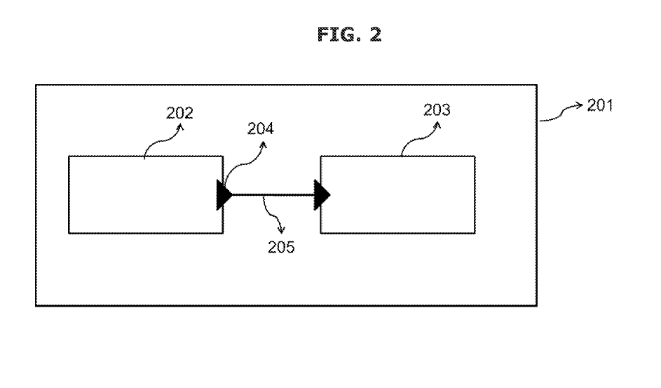

FIG. 2 schematically shows one possible embodiment of a graphical modeling environment (201) for the architecture of an overall program (1). FIG. 2 contains a graphical modeling environment (201), a first model element (202), a second model element (203), a third model element (205) and a fourth model element (204).

In this exemplary embodiment, the overall program (1) has a first program and a second program, wherein the first program (11) is represented by a first model element (202), and the second program (21) is represented by a second model element (203). The programs are linked to one another, for example, in such a manner that the first program (11) stores a first value of a first variable (12) in a first memory area of a memory, and a second program (21) with a second variable reads the first value of the first variable (12) out from the first memory area. This link is represented in the graphical modeling environment (201) by a third model element (205). In the embodiment shown, the first variable (12) is represented by a fourth graphical model element (204).

With the aid of a modeling environment, such as is shown in FIG. 2, the individual functionalities of programs can be integrated into components of an overall program (1) at the architecture level, and the communication there between can be defined. Moreover, the requirements and designations can be defined of the various components and variables of the overall program (1).

An architecture of an overall program (1) describes the basic components and their interaction within an overall program (1), wherein the overall program (1) includes at least one program or at least one individual functionality. The architecture can contain information about the structure and componentization of an overall program (1), but can also contain information about the communication between components, and their mapping to hardware or software resources.

Oftentimes, graphical modeling environments are used for development of the program architecture. Here the applicable programs or parts of programs, and their connections, as well as other elements of the architecture, can be represented by graphical model elements, such as blocks and lines, for example. This makes the development procedure simple and intuitive. As a rule, the connecting lines label the transmission or requesting of data, which is to say values of memory areas. Transmitted data can trigger program status changes (3), such as, e.g. the execution of a program or part of a program, which can be represented in the model by a block. However, program status changes (3) can also be initiated in other ways, such as through time-based triggering, for example. A transmission of data or a change to data can likewise be defined as a program status change (3).

Once the architecture has been defined and specified, the descriptions of the components, including their communications interface, can be relayed to the applicable function developers so that they can implement the functionalities of the programs. Once this step has been completed, the implementations or programs can be returned to the architecture developer or software integrator, wherein the implementations are integrated into the modeling environment (201), and an overall program (1) can be produced.

Especially in the development of the overall program (1) for an electronic control unit, errors that are typical for control units can arise. These errors result from the characteristic features of the architecture of an overall program (1) of a control unit: In an overall program (1) of a control unit, it is possible to execute, within a runtime environment, the individual programs that can be linked to the hardware and the connected I/O functionalities or communications systems of the control unit through a control unit operating system by means of a variety of drivers and services. The connection of all components of the software of a control unit can be established through interfaces. Another characteristic feature in the architecture of control unit programs resides in the fact that programs of an overall program (1) that are linked to one another can be executed on different control units without the need for the programs to be adapted to the applicable control unit.

An important source of errors in the development of an overall program (1) of an electronic control unit resides in the distribution of the system. In contrast to a conventional program, an overall program (1) of an electronic control unit has many individual functionalities and programs that communicate through, e.g., a bus (e.g., CAN, Flexray, etc.). As a general rule, this is difficult for a developer to keep a clear overview of.

Another source of errors in the development of an overall program (1) of an electronic control unit resides in the distribution of the development and the associated possible errors in the transmission of the data, e.g. incorrect versions or incorrect compiler flags, as well as in the complex toolchains associated with the development.

Consequently, a variety of errors can occur in the modeling and integration of an architecture as well as in the development of the programs or parts of programs, especially in the case of programs and architectures for electronic control units. These errors can be detected in simulation-based testing and experimentation. In addition, implementation and design errors can occur in the interaction of the programs in the overall program (1) that did not occur in the unit or module test, which tests the functionality of an isolated program. When an error occurs, its cause must be found, yet oftentimes the cause is not located where the error first becomes visible, such as in the plot of a measurement variable in the case of experimentation or in the case of automated testing for a specific value.

The errors can be of various types. For instance, one source of error is that the requirements specified in the architecture model are not realized or are realized only partially in the program implementations. This can then manifest itself, for example, in that certain programs write into data areas to which they should have no access according to the architecture model, allowing them to illegally influence and change data.

A simulation-based test method is customarily used to find the errors. To this end, the source code (or requisite source code files for software components, programs, runtime environment, control unit operating system, services, drivers, etc.) underlying the overall program (1) or parts thereof is compiled and linked, and the resultant overall program (1) is then executed. This execution can take place either directly on the control unit or as a virtual control unit in an offline simulation. In an offline simulation the simulator is not connected to a physical control unit, and is thus independent of real time.

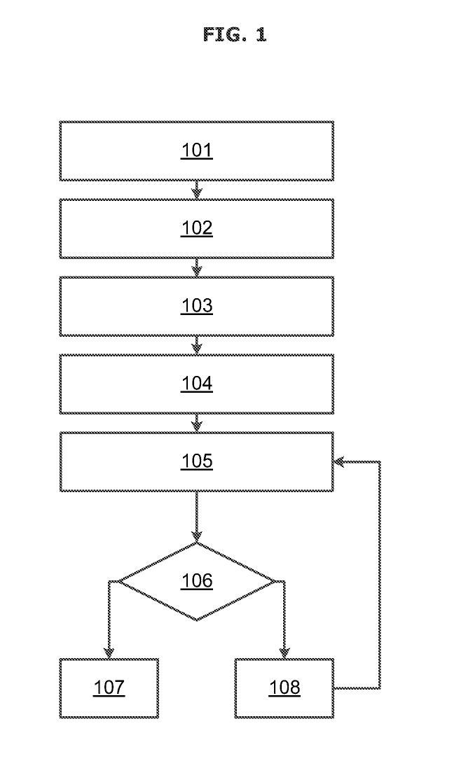

FIG. 1 shows an embodiment of the functional sequence of a method according to the invention, wherein a first step (101), a second step (102), a third step (103), a fourth step (104), a fifth step (105), a sixth step (106), a seventh step (107), and/or an eighth step (108) are carried out.

In the first step (101), a halt condition (2) is specified by means of a graphical modeling environment (201), wherein a program status change (3) leading to interruption of the execution of the overall program (1) is specified by means of the halt condition (2).

In an embodiment, it is preferred in this step for specification of the halt condition (2) to take place in such a way that the first model element (202) and/or the second model element (203) is selected in a first step, a selection and/or input takes place in a second step, wherein it is specified with the selection and/or input that the program execution should be interrupted upon the start and/or end of the execution of the first program (11) and/or upon the start and/or end of the execution of the second program (21), and that the execution of the overall program (1) is interrupted upon the start and/or end of the execution of the first program (11) and/or upon the start and/or end of the execution of the second program (21).

In another embodiment, it is preferred in this step that specification of the halt condition (2) takes place in such a way that the third model element (205) is selected in a first step, a selection and/or input takes place in a second step, wherein it is specified with the selection and/or input that the program execution should be interrupted upon a read and/or write access to the first value of the first memory area and/or upon a change to the first value of the first memory area, and that the execution of the overall program (1) is interrupted upon a read and/or write access to the first value of the first memory area and/or upon a change to the first value of the first memory area.

Selection of the applicable model element can be accomplished through a mouse click by a user on a model element, for example. The selection and/or input can also take place by means of a list, with multiple model elements being available for selection in the list. The selection and/or input can also take place by means of text specification of an identifier of a model element. One possible implementation provides for a context menu to appear in response to a mouse click on a model element for representing the first program (11), wherein it is indicated in the context menu that a halt condition (2) should be specified here, whereupon it is indicated in another step that the execution of the overall program (1) should be interrupted at a start of execution of the first program (11). Another possibility for specifying the halt condition (2) is a text statement in the form: “first program=start.”

Another way of specifying the halt condition (2) is that RTE events that are defined by the AUTOSAR standard are considered program status changes (3) in the event of which the execution of the overall program (1) should be interrupted. According to the AUTOSAR specification, which can be found at www.autosar.org, examples of an RTE event include TimingEvent, BackgroundEvent, DataReceivedEvent, DataWriteCompletedEvent, OperationInvokedEvent and InternalTriggerOccurredEvent.

The possible halt conditions (2) can depend on the type of model element. Examples of possible halt conditions (2) that can be defined at the model element are the start or termination of the program, or start and termination of subprograms, functions, runnables, or tasks of the program.

An embodiment of a halt condition (2) definition can reside in that a mouse click on a model element opens a menu in which assignment with a halt condition (2) can be selected. Furthermore, an additional window can open in which additional parameters can be specified for the halt condition (2).

In an embodiment, an input can be obtained through a mouse click on a model element, e.g., program component, port, or connecting line, for example with the aid of a menu, by which means a halt condition (2) is defined specifically for the model element in question. Furthermore, a selection of possible program status changes (3) and memory areas that are associated with the particular element can be provided. Then one or more program status changes (3) and/or memory areas can be assigned halt conditions (2).

In the second step (102) of an embodiment of the method according to the invention, a mapping of the graphical model elements to corresponding locations in the program code of the overall program (1) or of the programs takes place.

The following can be considered program code, for example: machine code, binary code, assembler code, source code, intermediate code, a source program, etc.

Information from the program architecture can be used for the mapping, wherein the mapping can be carried our very efficiently if the architecture satisfies a predefined specification. The specification can be predefined by the AUTOSAR standard, for example. The specification of the architecture can predefine rules for the naming of the programs, subprograms, tasks, data elements, functions, runnables, and/or variables.

The mapping, which is to say an identification of the places in the program code that are represented by graphical model elements, is made possible by the means that the overall program (1) is modeled in accordance with the specifications of the AUTOSAR standard through the graphical modeling environment (201), and a program code of the overall program (1) and/or a program code of the first program (11) is present, wherein the program code at least partially meets the specifications of the AUTOSAR standard, and the first model element (202) and/or the second model element (203) and/or the third model element (205) and/or the fourth model element (204) represents a component of the program code of the overall program (1) and/or a component of the program code of the first program (11).

In an embodiment the mapping is accomplished by a determination of the position of a component of the program code of the overall program (1) and/or of the component of the program code of the first program (11), wherein the component of the program code represents the first model element (202) and/or the second model element (203) and/or the third model element (205) and/or the fourth model element (204). The component can be, for example, an instruction that initiates an execution of the first program (11) or that initiates a memory access to a memory area.

In the third step (103) of an embodiment of the method according to the invention, an identification of breakpoints in the program code and a communication of the breakpoints to a source code debugger, such as, e.g., the program “GNU Debugger,” takes place. A breakpoint is understood to be a particular location in the program code, wherein an instruction is executed at the location, and the program execution is supposed to be stopped either before or after the instruction. In an embodiment, breakpoints for all locations in the program code that are linked to a graphical model element are communicated to the source code debugger. In another embodiment, only the locations in the program code where a command is executed are communicated to the source code debugger, and the command is linked to a graphical model element, wherein a halt condition (2) has been specified for the applicable graphical model element. A linking of an instruction to a graphical model element is provided, for example, by the means that the execution of a program is initiated by the instruction, with the program being represented by a graphical model element, or that a memory access to a memory area is initiated by the instruction, and variables are assigned to the memory area, with the variables being represented by a graphical model element.

In an embodiment of the method according to the invention, what takes place in the third step (103) is that a program instruction for detecting the program status change (3) and/or interrupting execution of the overall program (1) is inserted before and/or after the position of the component of the program code, or the component of the program code is replaced by a program instruction for detecting the program status change (3) and/or interrupting the execution of the overall program (1). As a result of the program instruction, target addresses in the assembler code or binary code of the program or overall program (1) are redirected, for example. In another embodiment, additional functions that contain mechanisms for detecting and interrupting program execution are called by the program instructions.

In the fourth step (104) of an embodiment of the method according to the invention, a start of the execution of the overall program (1) begins. In an embodiment, this step includes generation of an executable overall program (1), for example through compilation and linking, on the basis of the communication of the first program (11) with the second program, which is described with the modeling environment (201). In an embodiment, this step also includes the generation of a runtime environment, known as RTE in the AUTOSAR specification, wherein the runtime environment is construed as part of the overall program (1).

In an embodiment according to the invention, the source code underlying the overall program (1), which is to say source code files for software components, runtime environment, control unit operating system, services, drivers, or the like, or parts thereof, is compiled and linked, and the resultant overall program (1) is then executed. This execution can take place either directly on the control unit or as a virtual control unit in an offline simulation.

In the fifth step (105) of an embodiment of the method according to the invention, program status changes (3) are detected during the execution of the overall program (1), wherein a start and/or end of the execution of the first and/or second program (21), and/or a read and/or write access to the first value of the first memory area, and/or a change in the first value of the first memory area, is considered a program status change (3). In an embodiment, this detection is accomplished by means of the approaches described in the third step (103), which is to say by means of a source code debugger or by means of program instructions added to the program code. In an alternative embodiment, the detection is carried out using a simulation environment, wherein the simulation environment controls and monitors the execution of the overall program (1). Another possible embodiment provides for a simulation of the processor instruction set of a target control unit, and this simulation is used for detection. The use of hook functions for accomplishing the detection represents an additional embodiment according to the invention.

In the sixth step (106) of an embodiment of the method according to the invention, after a program status change (3) has been detected, a check takes place of whether the detected program status change (3) is supposed to bring about an interruption of the program execution.

In the event of a positive check in the sixth step (106), an interruption of program execution takes place in the seventh step (107) of an embodiment of the method according to the invention.

In the event of a negative check in the sixth step (106), a continuation of the detection of program status changes (3) takes place in the eighth step (108) of an embodiment of the method according to the invention.

In an embodiment of the invention, a source code section is displayed after the interruption of the execution of the overall program (1), wherein the source code section is assigned to the occurrence of the halt condition (2).

In another embodiment according to the invention, when the program execution is interrupted a value of a variable in a memory area or a halt condition (2) is modified, and then the execution of the overall program (1) is continued.

An embodiment according to the invention can additionally include that, after an event is detected, the detections are stored in chronological order in a tabular representation, and/or the value of the first variable (12) and/or the value of the second value and/or the start, the execution, or the end of the first program (11) and/or the start, the execution, or the end of the second program (21) are graphically displayed in the graphical modeling environment (201). In an embodiment, the tabular representation is updated after each detection, and contains additional attributes, such as the value assignments of memory areas. Starts and terminations of programs or parts of programs, and also read and write accesses to values of memory areas, for example, are stored and displayed here.

In an embodiment, the value of the first variable (12) and/or the value of the second value, and/or the start, the execution, or the end of the first program (11), and/or the start, the execution, or the end of the second program (21) can be displayed in the graphical modeling environment (201) during the execution of the overall program (1) or during the interrupted execution of the overall program (1). This can be implemented such that, when program status changes (3) occur, such as program starts or terminations, or accesses to or changes of memory areas, the applicable model elements are emphasized, for example in the form of a color change or an animation. In addition, current values of memory areas can be graphically displayed in the vicinity of a model element.

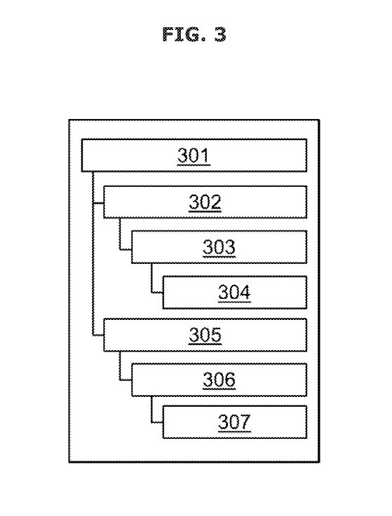

FIG. 3 shows an embodiment of a hierarchical tree structure, wherein the hierarchical tree structure in this embodiment includes seven nodes, and the first node (301) represents the overall program (1), the second node (302) represents the first program (11), the third node (303) represents the first variable (12), the fourth node (304) represents the first memory area, the fifth nodes (305) represents the second program (21), the sixth node (306) represents the second variable, and the seventh node (307) represents the first memory area. In an embodiment, specification of the halt condition (2) takes place in such a manner that the second node (302) is selected in a first step, and a selection and/or input takes place in a second step, wherein it is specified with the selection and/or input that the program execution should be interrupted upon the start and/or end of the execution of the first program (11).

The invention being thus described, it will be obvious that the same may be varied in many ways. Such variations are not to be regarded as a departure from the spirit and scope of the invention, and all such modifications as would be obvious to one skilled in the art are to be included within the scope of the following claims.

What is claimed is:

1. A method for interrupting an execution of an overall program of an electronic control unit, the overall program having a first program and a second program, the method comprising:
providing the first program with a first variable, the first program storing a first value of the first variable in a first memory area of a memory or reading the first value of the first variable out from the first memory area;
providing the second program with a second variable, the second program storing the first value of the first variable from the first memory area of the memory or reading the first value of the first variable out from the first memory area of the memory in order to establish a link between the first program and the second program;
providing a graphical modeling environment, the modeling environment having graphical model elements, wherein, in the graphical modeling environment, the first program is represented by a first model element and the second program is represented by a second model element, and the link between the first program and the second program is represented by a third model element;
specifying a halt condition via the modeling environment, the halt condition specifying a program status change leading to interruption of the execution of the overall program;
executing the overall program;
detecting a program status change during execution of the overall program, wherein a program status change comprises: a start and/or end of the execution of the first program and/or second program; and/or a read and/or write access to the first value of the first memory area; and/or a change in the first value of the first memory area; and
interrupting the execution of the overall program when the program status change specified in the halt condition occurs.

2. The method according to claim 1, wherein specification of the halt condition takes place such that:
the first model element and/or the second model element is selected in a first step; and
a selection and/or input takes place in a second step, wherein it is specified with the selection and/or input that the program execution should be interrupted upon the start and/or end of the execution of the first program and/or upon the start and/or end of the execution of the second program, and
wherein the execution of the overall program is interrupted upon the start and/or end of the execution of the first program and/or upon the start and/or end of the execution of the second program.

3. The method according to claim 1, wherein specification of the halt condition takes place such that:
the third model element is selected in a first step;
a selection and/or input takes place in a second step, wherein it is specified with the selection and/or input that the program execution should be interrupted upon a read and/or write access to the first value of the first memory area and/or upon a change to the first value of the first memory area, and
wherein the execution of the overall program is interrupted upon a read and/or write access to the first value of the first memory area and/or upon a change to the first value of the first memory area.

4. The method according to claim 1, wherein the first variable is represented by a fourth graphical model element, and specification of the halt condition takes place such that:
the fourth model element is selected in a first step;
a selection and/or input takes place in a second step, wherein it is specified with the selection and/or input that the program execution should be interrupted upon a read and/or write access to the first value of the first memory area and/or upon a change to the first value of the first memory area, and
wherein the execution of the overall program is interrupted upon a read and/or write access to the first value of the first memory area and/or upon a change to the first value of the first memory area.

5. The method according to claim 1, wherein the modeling environment comprises a hierarchical tree structure that includes a node, the node representing the first program and/or the first variable and/or the first memory area, wherein specification of the halt condition takes place such that the node is selected in a first step, and wherein a selection and/or input takes place in a second step, wherein it is specified with the selection and/or input that the program execution should be interrupted upon the start and/or end of the execution of the first program and/or upon a read and/or write access to the first value of the first memory area and/or upon a change to the first value of the first memory area.

6. The method according to claim 1, wherein the first program comprises a subprogram and/or a function, and wherein a start and/or end of the execution of the subprogram and/or a start and/or end of the execution of the function is considered a program status change, and wherein the execution of the overall program is interrupted upon a start and/or end of the execution of the subprogram, and/or upon a start and/or end of the execution of the function.

7. The method according to claim 1, wherein the overall program is modeled in accordance with the specifications of the AUTOSAR standard via the graphical modeling environment, wherein a program code of the overall program and/or a program code of the first program is present, the program code at least partially meeting the specifications of the AUTOSAR standard, and wherein the first model element and/or the second model element and/or the third model element and/or the fourth model element represents a component of the program code of the overall program and/or a component of the program code of the first program.

8. The method according to claim 7, wherein the AUTOSAR standard defines an RTE event, and the RTE event is considered a program status change, and wherein the execution of the overall program is interrupted when the RTE event occurs.

9. The method according to claim 7, wherein a source code debugger is provided, and the execution of the overall program and the detection of the program status change via the source code debugger are carried out such that a breakpoint in the source code is identified by the halt condition, and wherein the breakpoint is communicated to the source code debugger.

10. The method according to claim 7, wherein the component of the program code of the overall program and/or the component of the program code of the first program occupies a unique position within the program code, the position is identified, and a program instruction for detecting the program status change and/or interrupting the execution of the overall program is inserted before and/or after the position, or wherein the component of the program code is replaced by a program instruction for detecting the program status change and/or interrupting the execution of the overall program.

11. The method according to claim 7, wherein the component of the program code of the overall program and/or the component of the program code of the first program occupies a unique position within the program code, the position is identified, and a section of program code of the overall program and/or of the program is displayed, wherein the program code section contains the component, and wherein the program status change specified in the halt condition takes place by the component.

12. The method according to claim 1, wherein the program status change is stored in a chronological database if it does not result in an interruption of the program execution.

13. The method according to claim 1, wherein a modification of the first value of the first variable from the first memory area is performed, wherein the modification is made after the interruption of the execution of the overall program, and wherein, following the modification, the execution of the overall program is continued.
